(19) United States
(12) Patent Application Publication
(10) Pub. No.: US 2016/0098501 A1
(43) Pub. Date: Apr. 7, 2016

(54) VIRTUAL SENSORS SUPPORTED BY A COMPUTER AIDED DESIGN (CAD) MODEL AND SOFTWARE

(71) Applicant: PTC Inc., Needham, MA (US)

(72) Inventors: Michael A. REITMAN, Zikhron Yacov (IL); Moshe Jacob BAUM, Boston, MA (US); Eldad FINKELSTEIN, Haifa (IL)

(21) Appl. No.: 14/870,909

(22) Filed: Sep. 30, 2015

Related U.S. Application Data
(60) Provisional application No. 62/060,308, filed on Oct. 6, 2014.

(51) Int. Cl. G06F 17/50

(52) U.S. Cl. CPC G06F 17/5009

(57) ABSTRACT

Virtual sensors may be provided to accept outputs of physical sensors as inputs in a model of a system that represents a product. The outputs of the virtual sensors are calculated from physical sensor outputs. In particular, the virtual sensors are calculated by exploiting information and analysis provided in a computer aided design (CAD) environment, including a CAD model and CADs simulation engine.

### RELATED APPLICATION

This application claims the benefit of U.S. Provisional Patent Application No. 62/060,308, filed on Oct. 6, 2014, for all subject matter common to said applications. The disclosures of all of the above-mentioned applications are hereby incorporated by reference herein in their entirety.

### BACKGROUND OF THE INVENTION

In computer aided design (CAD), a designer uses computer tools to develop a design of a product. The resulting design is captured in a computer model. Various uses of the product may be simulated using the computer model to predict product behavior or response under given conditions (in tools sometimes also referred as computer aided engineering (CAE)). The results of the simulations may be used to realize behavior, and modify and refine the design of the product.

### SUMMARY OF THE INVENTION

In accordance with one aspect of the present invention, a method may be practiced in a computing device having a processor. In this method a computer aided design (CAD) service is provided. The CAD service receives an output of a physical sensor that is positioned on a product. The output is associated with at least one parameter in a CAD model of the product. The CAD model has a virtual sensor. The virtual sensor uses the output of the physical sensor to calculate an output. A simulation of the CAD model is initiated where the output of the physical sensor is an input to the simulation. Results of the simulation are received. The results include a calculated value for the output of the virtual sensor. The output of the virtual sensor is reported based on the results of the simulation. Instructions for performing the steps of this method may be stored on a non-transitory computer-readable storage medium.

In accordance with another aspect of the present invention, a method is practiced on a computing device having a processor where a virtual sensor is defined on a CAD model of a product with the processor. The CAD model holds information regarding the product. Output from a physical sensor positioned to acquire physical information of a product that is in use is received. The physical sensor senses the physical property. An output of the virtual sensor is calculated with the processor based on some information held in the CAD model and the output of the physical sensor. Instructions for performing this method may be stored in a non-transitory computer-readable storage medium.

### BRIEF DESCRIPTION OF THE DRAWINGS

FIG. 1 depicts an example of an excavator that has physical sensors and has corresponding virtual sensors in an associated CAD model in accordance with exemplary embodiments described herein.

FIG. 2 shows an example of a dashboard that may be provided when physical sensors and virtual sensors provide feedback regarding operation of multiple excavators.

FIG. 3 shows an example of a display that may be provided to the excavator operator in an exemplary embodiment.

FIG. 4 is a block diagram that illustrates the flow of information from a physical sensor to a virtual sensor and ultimately to a dashboard in an exemplary embodiment.

FIG. 5 shows an example of physical properties that may be calculated by virtual sensors based on the CAD model in exemplary embodiments.

FIG. 6 is a block diagram of a system for practicing exemplary embodiments described herein.

FIG. 7 shows an example case in which a server and a display are incorporated directly on a product.

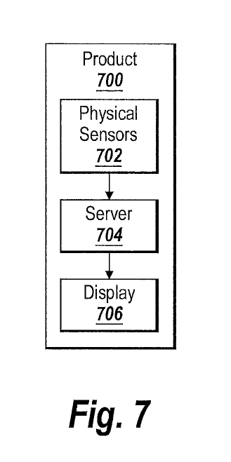

FIG. 8 is a block diagram of a computing device suitable for serving as the server and/or client in exemplary embodiments.

FIG. 9 is a flow chart illustrating steps performed in the design cycle of a product.

FIG. 10 is a flow chart providing an overview of steps that are performed to utilize both physical sensors and virtual sensors in the exemplary embodiments described herein.

FIG. 11 is a flowchart illustrating the steps performed in creating and positioning a virtual sensor.

### DETAILED DESCRIPTION

Traditionally, CAD has been used during the design phase of a product. The exemplary embodiments described herein also use CAD during the use phase of a product. In particular, the exemplary embodiments leverage aspects of CAD during the use phase of a product to implement a service that provides valuable information regarding use of the product. As will be described in more detail below, the service may support the use of virtual sensors that provide measurements of physical properties like physical sensors but that are not physically present on the product; rather the virtual sensors are realized via software.

It is helpful to deploy physical sensors on a product and obtain feedback from the physical sensors while the product is in use. Unfortunately, there are certain limitations with physical sensors. Often times it is difficult to attach physical sensors to desired locations or to directly acquire the desired type of measurement. Moreover, physical sensors may be expensive and may not provide all of the information that a user, observer or other system(s) wishes to obtain from use of a product.

The illustrative embodiments described herein provide “virtual sensors” that accept outputs of physical sensors as inputs to the virtual model of the system, and generate outputs for values calculated from the physical sensor outputs. The virtual sensors are calculated by exploiting the information and analysis provided in a CAD environment that includes a CAD model and a CAD simulation engine (may also be referred as CAE tool). These virtual sensors have a higher degree of accessibility than physical sensors in that the virtual sensors can be placed in the products where physical sensors cannot be placed due to mechanical, thermal or other constraints. Moreover, the virtual sensors do not have the associated cost of physical sensors and can be readily reconfigured. The virtual sensors also have the advantage that you may get better coverage of sensing on a product with just a few physical sensors. For example, dozens of virtual sensor measurements may be derived from only a handful of physical sensors while still providing excellent coverage of the entire product.

The exemplary embodiments are able to leverage the CAD environment to provide virtual sensors. The CAD environment possesses information regarding the product in the CAD model and has knowledge regarding use of the product via the simulation engine. The ability to provide virtual sensors can be provided as part of a service that can also provide real time on demand feedback regarding use of the product, as well as retrospective reconstruction and analysis of recorded events or sequences. The CAD model need not be a full blown CAD model but rather may be a more limited CAD analysis model that possesses the requisite parameters needed to provide the service and calculate the virtual sensor outputs.

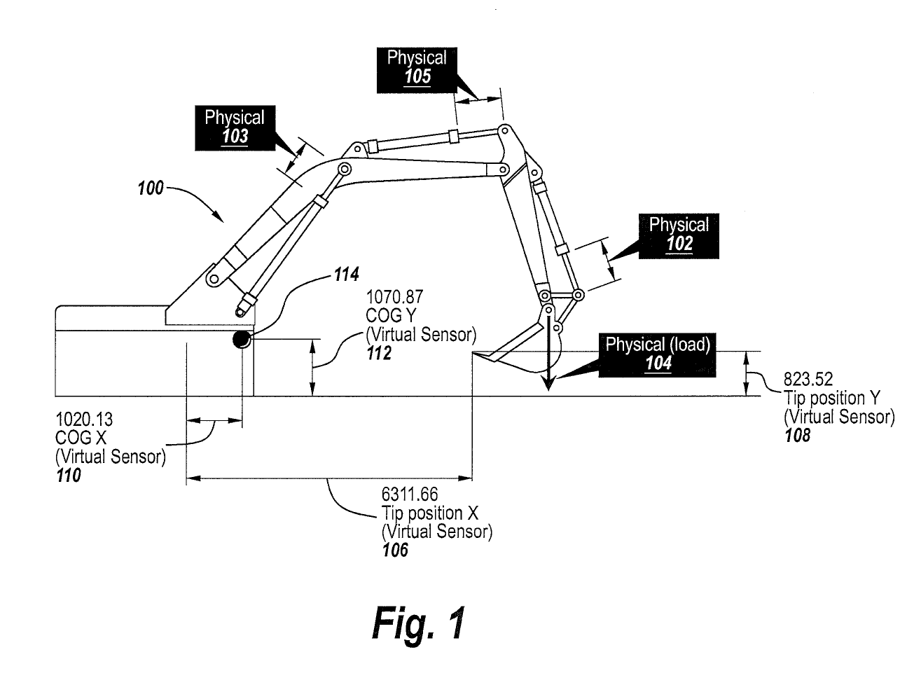

An example is helpful to better understand how the CAD service and the virtual sensors are used in illustrative embodiments described herein. FIG. 1 depicts an excavator, such as used in construction and land moving operations. The excavator 100 includes physical sensors 102, 103, 104 and 105. Physical sensors 102, 103 and 105 measure the extent of actuation of the respective actuators (e.g. by a linear encoder) on the excavator, and physical sensor 104 senses the load of the bucket of the excavator. In illustrative embodiments described herein, virtual sensors 106 and 108 may be provided. Virtual sensor 106 calculates the position of the bucket tip in the X direction and virtual sensor 108 calculates position of the bucket tip in the Y direction. Virtual sensors 110 and 112 may also provided to calculate the center of gravity for the excavator (or a portion of it, like the mechanism of the moving arm). The depiction in FIG. 1 includes a dot 114 that corresponds to location of the center of gravity for the excavator. These virtual sensors receive the feedback from the physical sensors and calculate the corresponding values. Some calculations, like those described herein, may be calculated per single sampling point set of values. Other measures, like dynamic calculations (forces, accelerations, etc.), may be calculated on consequent sampling points.

As will be explained in more detail below, the CAD environment may provide a service to a user or system that provides details regarding the outputs of the physical sensors and virtual sensors during operation of the product. The CAD service may manifest itself in different fashions as will be elaborated on more below. The CAD service generally refers to software that provides the described functionality and communicates with other software, such as identified below.

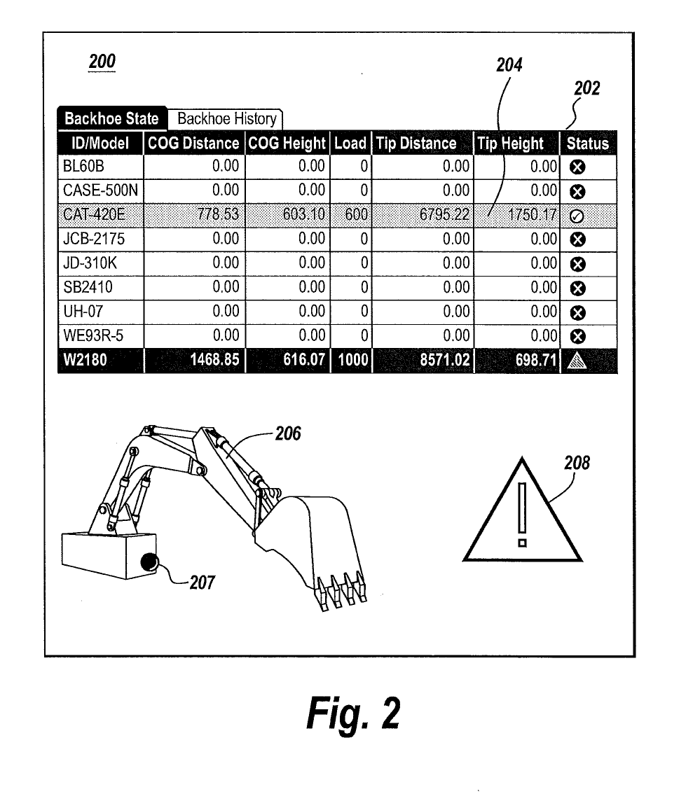

FIG. 2 shows a dashboard 200 that may be provided relative to the operation of multiple excavators. This dashboard 200 may be provided as a service to the owner of the excavators, such as a construction company. The dashboard 200 includes a table 202 that specifies information regarding the excavators. In this example case, each excavator is associated with a row of the table 202 that provides real time information regarding the excavator from the physical sensors and the virtual sensors. In the case depicted in FIG. 2, the third row 204 is selected. An animation 206 of the associated excavator is provided. This animation includes a dot 207 that indicates the center of gravity for the excavator.

An alert icon 208 indicates that in current operation, the monitoring system indicates that an alert has been triggered based upon output values from the virtual sensors. The alert may indicate, for example, that the load is too great or that the excavator is being operated in a potentially dangerous or harmful manner. The values may be displayed on demand in real time via the dashboard 200. The operator of the excavator may take remedial action in response to the alert to avoid damaging the excavator or causing an accident. A check mark icon may be displayed to indicate that the excavator is operating within acceptable limits. Thus, the operator is reassured that he is operating the excavator safely.

The dashboard 200 may be provided on a client computer device or on a display that is coupled to a server. Alternatively, the display may be provided on the product. The dashboard 200 serves as a vehicle for remote monitoring and display of alerts. The dashboard 200 may display physical output values, virtual sensor outputs, alerts and other feedback information.

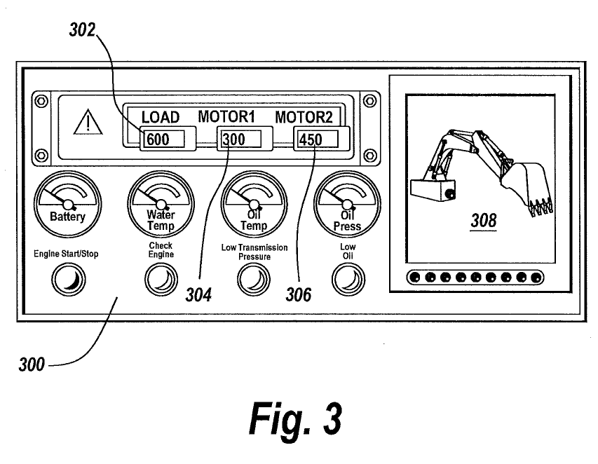

FIG. 3 shows an example of an exemplary display 300 for an excavator. The excavator display 300 includes an output value 302 for the load on the excavator as well as an output value 304 for a first motor and an output value 306 for a second motor. An animation of the excavator 308 may also be displayed as part of the dashboard display 300. This display 300 may be positioned on the instrument panel of the excavator to provide real time feedback to the operator of the excavator.

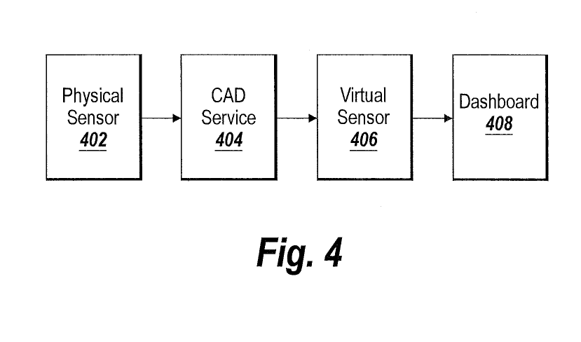

FIG. 4 is a block diagram that depicts the flow of information from a physical sensor 402 in exemplary embodiments. As shown in FIG. 4, the physical sensor 402 senses a physical property and provides the output to the CAD service 404 that is provided by the CAD environment. Physical sensors outputs are effectively passed as inputs to the CAD simulation model to calculate output of a virtual sensor 406. The virtual sensor 406 is part of the CAD model. The virtual sensor may be provided with parameters that identify the virtual sensor as a sensor and that identify the source of its “values.” As will be explained in more detail below, the CAD environment uses the resident knowledge in the system's virtual CAD model that is mapped to the physical product being tracked, and the simulation engine, to calculate output values for the virtual sensor 406. The virtual sensor 406 uses the physical sensor output to calculate a virtual sensor output that is then passed to the dashboard 408.

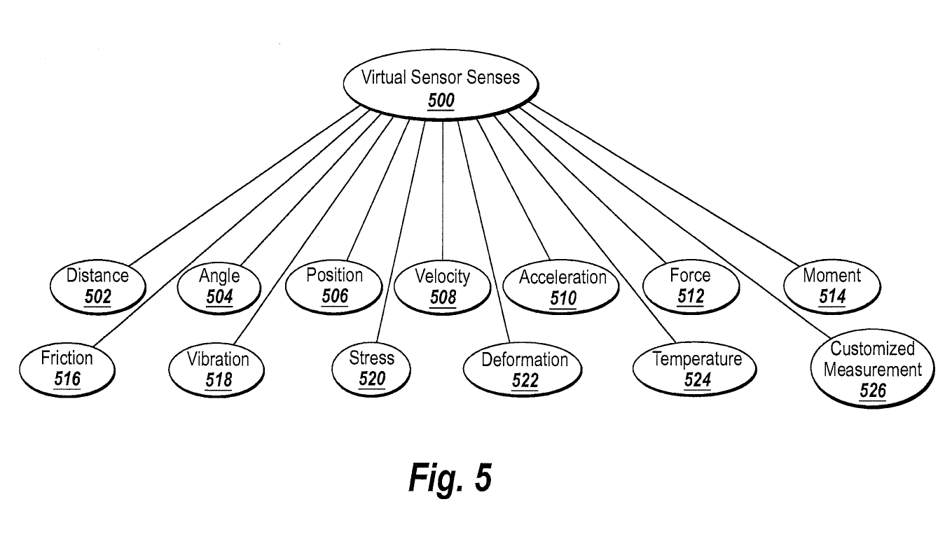

The physical properties that are sensed by virtual sensors are incorporated into the CAD model, and the CAD model includes representations of the physical sensors. FIG. 5 shows an example of some of the physical properties that a virtual sensor may sense 500. These examples are not intended to be exhaustive, but rather are intended to be simply illustrative. The virtual sensor may sense distance 502 and well as angle 504 or position 506. The virtual sensor may determine velocity 508 or acceleration 510. Moreover, the virtual sensor may calculate force 512 or a moment 514. The virtual sensor may sense friction 516, vibration 518, stress 520 or deformation 522. The virtual sensor may also sense temperature 524. Lastly, the virtual sensor may sense any customized measurement 526 that may be identified using the physical sensor output and information and analysis provided within the CAD environment. Multiple virtual sensors may be defined and calculated over single CAD model and/or simulation run.

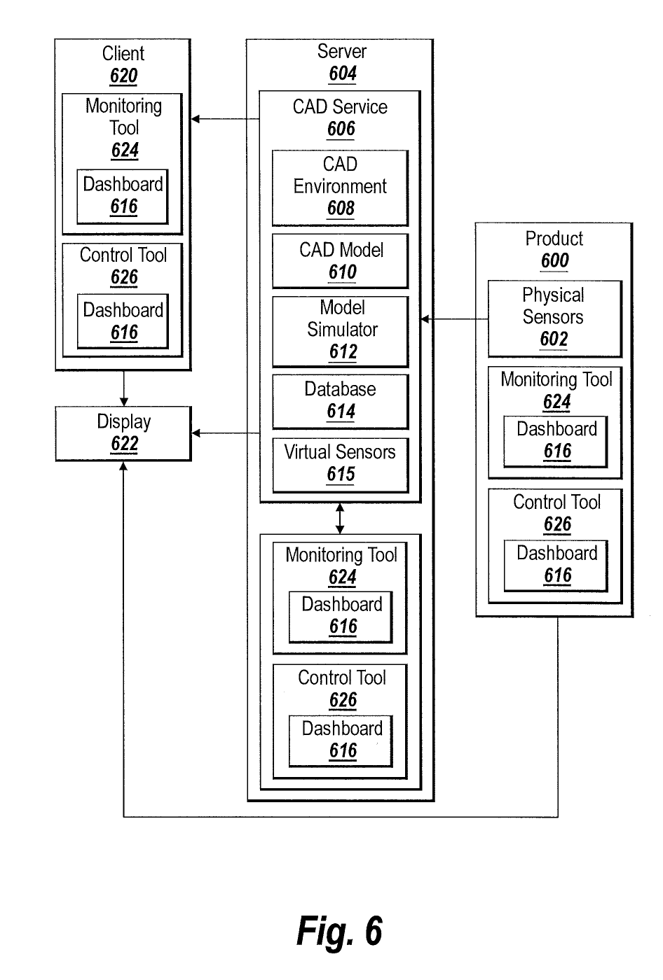

FIG. 6 depicts a computing environment that is suitable for practicing illustrative embodiments described herein. As shown in FIG. 6, a product 600 includes one or more physical sensors 602. The output of the physical sensors 602 is passed to a server 604. This server 604 may be physically coupled to the product 600 or may be coupled via a wireless connection or other communication network connection. The server 604 may be located on a cloud or other network facility. The server 604 includes a CAD environment 608. The CAD environment 608 may include, for example, the PTC Creo suite of product design software that is provided by PTC, Inc. of Needham, Mass. The server 604 may also include a platform designed to capture information from a product, such as the ThingWorx solution provided by PTC, Inc. The platform enables output from the physical sensors 602 to be captured and sent to the server 604.

A CAD service 606 may be provided that gathers the output of the physical sensor(s) 602, passes the output to a CAD model 610 and a model simulator 612. The CAD service 606 calculates virtual sensor(s) 615 output(s) by analyzing the physical sensor(s) output(s) for downstream uses, like displaying on a dashboard 616. A database 614 may be provided to store physical sensor(s) output and virtual sensor(s) output as well as other data.

The CAD model 610 is a model of the product 600 and holds a good deal of information regarding the product and the components of the product. The CAD model 610 may include one or more assemblies, where each assembly is a collection of ports and each port may have one or more features. Property information is stored for the properties of the ports and assemblies. The CAD model 600 may be a geometric model where components have mass properties, such as volume, surface area, intertia, etc. The CAD model 610 may be a parametric model.

The model simulator 612 uses the CAD model 610 to simulate use of the product according to different use scenarios. Real world conditions may be specified for the simulation. A suitable simulator 612 is the PTC Creo Simulate product of PTC, Inc. The server 604 may output information to a monitoring tool 624 that monitors the product and/or a control tool 626 that controls operation of the product. Both tools 624 and 626 may include a dashboard 616. The dashboard 616 may be displayed on a display 622. The dashboard may be developed using a tool such as ThingWorx, which enables a user to create a dashboard as an arranged visualization of data. In some embodiments, the server 604 may output information to the tools 624 and 626 resident on a client 620. In other embodiments, the information is passed to tools 624 and 626 resident on the server, and in still other embodiments, the tools 624 and 626 may be resident on the product 600. FIG. 6 shows all three of these options.

As was mentioned above, in some embodiments, the server 704 may be located directly on the product 700. Thus, the physical sensor(s) 702 are coupled with the service 704 and resulting output is displayed on a display 706 that is resident on the product.

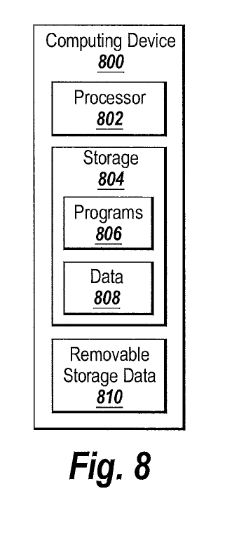

The server 604 may be a process running on a computing device 800 as shown in FIG. 8. Similarly, the client 620 may be a process running a computing device like that shown in FIG. 8 as well. The computing device 800 may include a processor 802. The processor 802 may be, for example, a microprocessor, a controller an ASIC, an FPGA or other suitable processing logic. The processor 802 executes instructions for the CAD environment 606 (FIG. 6) to provide the service 606, the CAD model 610, the model simulator 612, the virtual sensor 615, the dashboard 616, and the tools 624 and 626. These may be encoded in software instructions that are executed on the processor 802. The computing device 800 may include storage 804 that holds computer programs 806, such as described above, and data 808. The storage 804 may hold the database 614. The database 614 may in some alternative embodiments be stored remotely from the server 604. Computing device 800 may also include various removable storage media, such as optical storage media, magnetic storage media and other types of removable storage media such as thumb drives and the like. Thus, the computing device may include and/or operate with a number of different types of non-transitory computer-readable storage media.

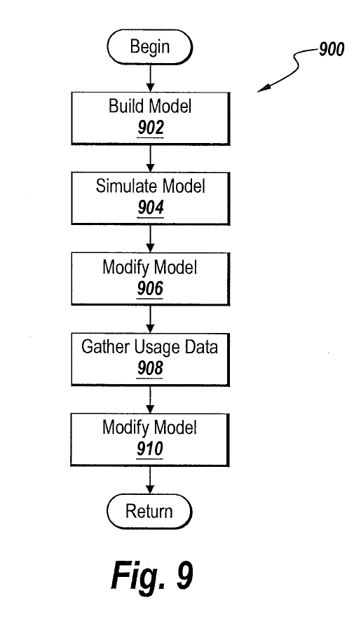

FIG. 9 is a flow chart 900 that illustrates how the exemplary embodiments may be useful in product design. Initially, a model of the product is built (step 902). This model is a CAD model of the product. The model (or a simplified from of it with reduced details to improve calculation performance) may then be simulated to obtain simulation results (step 904). The simulator results may include the output values from virtual sensors. Based upon the simulation results, the model may be modified (step 906). There may be multiple iterations of modifying the model and simulating the model to refine the model. After this design phase is completed, a physical product is built and is put into use. While in use, the invention is used to gather information from use of the product. Thus, usage data is gathered (step 908). Based upon this usage data, the model may be modified to optimize real world usage.

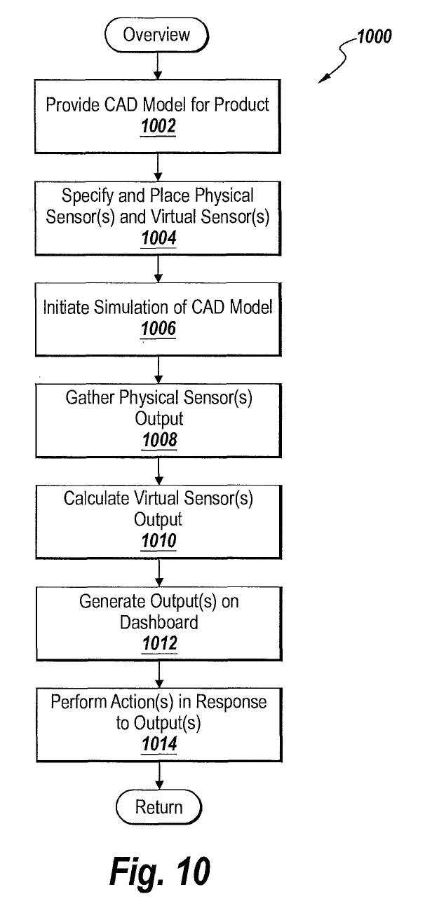

FIG. 10 provides a flowchart 1000 of the steps that are performed to use the CAD service and virtual sensors in accordance with illustrative embodiments described herein. Initially, a CAD model for the product is provided (step 1002). This, for example, may be the conventional CAD model. Next, a designer specifies places and/or definitions of physical sensors and virtual sensors on the product CAD model (step 1004). The physical sensors may require physically placing sensors on the respective product in order to associate their outputs as inputs to the CAD simulation. The virtual sensors are specified in the CAD environment, as discussed above.

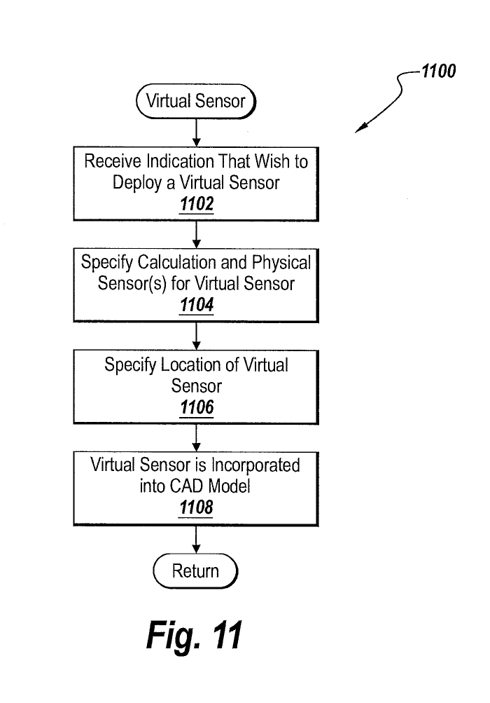

FIG. 11 shows a flowchart 1100 of the steps performed to specify a virtual sensor. The CAD environment may receive an indication that a user wishes to deploy a virtual sensor on the product (step 1102). The indication may be received by way of a user interface or programmatically. A method, e.g. formula, for calculating the output of the virtual sensor is specified (step 1104). In some cases, the user may specify this formula or calculation explicitly. The location of the virtual user or the product is specified (step 1106). This may be determined by specifying the location on the corresponding CAD model. The virtual sensor may then be incorporated into the CAD model or otherwise persistently stored (step 1108).

As shown in FIG. 10, a simulation of the CAD model may be then initiated (step 1006). During this simulation, the physical sensor output is gathered (step 1008). Those values are fed as inputs into the simulation of the CAD model that essentially corresponds to the actual activity of the product in use. Thus, the physical sensor output is received from the actual use and used to calculate/infer to the virtual sensor output (step 1010). The virtual sensor output and the physical sensor output may then be used to generate outputs on the dashboard (step 1012). The outputs need not be limited simply to the sensor output, but rather include additional output on the dashboard. For example, the alert icons such shown in FIGS. 2 and 3 and the animation of the product may be included on the dashboard.

Depending upon the nature of the outputs from the physical sensors and the virtual sensors, the monitoring system (e.g. PTC Thingworx platform) may perform an action in response to these outputs (step 1014). Examples of actions include displaying an alert, indicating that operation is within acceptable limits and performing any functionality that the product designer feels is necessary in response to the outputs from the physical sensors and virtual sensors.

While the present invention has been described herein with reference to illustrative embodiments thereof, those skilled in the art will appreciate that various changes in form and detail may be made without departing from the intended scope of the invention.

1. In a computing device having a processor, a method, comprising:
with a computer aided design (CAD) service, receiving an output of a physical sensor on a product, wherein said output is associated with at least one parameter in a CAD model of the product and wherein the CAD model has a virtual sensor that uses the output of the physical sensor to calculate an output;
causing a simulation of the CAD model to be initiated with the output of the physical sensor as an input to the simulation;
receiving results of the simulation, including a calculated value for the output of the virtual sensor; and
reporting the output of the virtual sensor based on the results of the simulation.

2. The method of claim 1, wherein the output of the physical sensor is received from a data storage.

3. The method of claim 2, wherein the physical sensor output is received from a database in the storage.

4. The method of claim 1, wherein the output of the physical sensor is received from the physical sensor.

5. The method of claim 1 wherein the CAD model has an additional virtual sensor that receives the output of the physical sensor and wherein the reporting further comprises reporting output of the additional virtual sensor based on the results of the simulation.

6. The method of claim 1, wherein the reporting comprises passing the output of the virtual sensor to a tool for monitoring the product.

7. The method of claim 1, wherein the reporting comprises passing the output of the virtual sensor to a tool that controls operation of the product.

8. In a computing device having a processor, a method, comprising:
with the processor, defining a virtual sensor on a computer aided design (CAD) model of a product, said CAD model holding information regarding the product;
receiving output from a physical sensor positioned to acquire physical information of a product that is in use, wherein the physical sensor senses a physical property; and
with the processor, calculating an output for the virtual sensor based on some of the information held in the CAD model and the output of the physical sensor.

9. The method claim 8, further comprising:
with the processor, defining multiple virtual sensors on the CAD model.

10. The method of claim 8, further comprising:
storing the output of the physical sensor and the output of the virtual sensor in a database.

11. A non-transitory computer-readable storage medium storing instructions that when executed on a processor of a computing device cause the processor to:
receive an output of a physical sensor on a product with a computer aided design (CAD) service, wherein said output is associated with at least one parameter in a CAD model of the product and wherein the CAD model has a virtual sensor that uses the output of the physical sensor to calculate an output;
cause a simulation of the CAD model to be initiated with the output of the physical sensor as an input to the simulation;
receive results of the simulation, including a calculated value for the output of the virtual sensor; and
report the output of the virtual sensor based on the results of the simulation.

12. The non-transitory computer-readable storage medium of claim 11, wherein the output of the physical sensor is received from a storage.

13. The non-transitory computer-readable storage medium of claim 12, wherein the output of the physical sensor is received from a database in the storage.

14. The non-transitory computer-readable storage medium of claim 11, wherein the output of the physical sensor is received from the physical sensor.

15. The non-transitory computer-readable storage medium of claim 11, wherein the CAD model has an additional virtual sensor that receives the output of the physical sensor and wherein the reporting further comprises reporting output of the additional virtual sensor based on the results of the simulation.

16. The non-transitory computer-readable storage medium of claim 11, wherein the reporting comprises passing the output of the virtual sensor to a tool for monitoring the product.

17. The non-transitory computer-readable storage medium of claim 11, wherein the reporting comprises passing the output of the virtual sensor to a tool that controls operation of the product.

18. A non-transitory computer-readable storage medium storing instructions that when executed on a processor of a computing device cause the processor to:
define a virtual sensor on a computer aided design (CAD) model of a product, said CAD model holding information regarding the product;
receive output from a physical sensor positioned to acquire physical information of a product that is in use, wherein the physical sensor senses a physical property; and
calculate an output for the virtual sensor based on some of the information held in the CAD model and the output of the physical sensor.

19. The non-transitory computer-readable storage medium of claim 18, further storing instructions for:
defining multiple virtual sensors on the CAD model.

20. The non-transitory computer-readable storage medium of claim 18, further storing instructions for:
storing the output of the physical sensor and the output of the virtual sensor in a database.
